(19) United States
(12) Patent Application Publication
(10) Pub. No.: US 2014/0148967 A1
(43) Pub. Date: May 29, 2014

(54) ELECTRONIC ACCESSORY FOR HEAT-TRANSFER ELECTRICAL APPLIANCES

(71) Applicant: Eliyahu Bayfus, Bnei Brak (IL)

(72) Inventor: Eliyahu Bayfus, Bnei Brak (IL)

(21) Appl. No.: 13/684,539

(22) Filed: Nov. 25, 2012

(51) Int. Cl. G05B 19/02

(52) U.S. Cl. CPC G05B 19/02
USPC 700/299

(57) ABSTRACT

An external electronic accessory is connectable between one or more sensors and control circuitry of a heat-transfer electrical appliance. The external electronic accessory includes a processor that selectively disconnects the one or more sensors from the control circuitry and produces a preset fake electrical signal for sending to the control circuitry of the heat-transfer electrical appliance.

### FIELD OF THE INVENTION

The present invention relates generally to sensors and control circuitry for heat-transfer electrical appliances, such as but not limited to, refrigerators and air conditioners, and more specifically to an external electronic accessory that is connected between the sensors and the control circuitry of the appliance and provides a Sabbath mode of operation.

### BACKGROUND OF THE INVENTION

Refrigerators, freezers, air conditioners, heaters, mini-bars, water coolers, and other electrical appliances that involve heat transfer, referred to herein as heat-transfer electrical appliances, are typically equipped with sensors, such as but not limited to, door opening sensors and temperature sensors, such as thermistors or thermocouples.

In refrigerators and freezers and other heat-transfer electrical appliances, there are typically components, such as a compressor, a fan, a motor, one or more lights, etc., whose operation is affected by changes in temperature, which may occur from various factors, such as opening and closing of a compartment door. This can cause a direct or indirect operation of an electrical circuit, which can be in violation of Sabbath observance. For example, in many refrigerators a simple mechanical, spring-loaded limit switch is closed by closing the refrigerator door and the switch opens by springing out when the door is opened. This is easily neutralized by mechanically maintaining the switch in the closed position, such as by tape or magnetic strip placed over the switch.

However, in modern refrigerators, more advanced switches are used to sense opening of the door, which cannot be so simply neutralized. Making matters worse for Sabbath observance is the fact that the door sensor counts every time the door is opened, which sends an electrical signal to a memory chip or other electronic component in the microprocessor circuitry that oversees control of the appliance. Thus opening the door causes direct or indirect recording of electronic data, which can be in violation of Sabbath observance.

In modern digital heat-transfer appliances, there are one or more temperature sensors (such as thermistors or other sensors) whose electrical resistance changes with temperature. The sensor constantly (or intermittently over some short period of time, e.g., every few milliseconds or even microseconds) sends an electrical signal to a memory chip or other electronic component in the microprocessor circuitry. Upon opening the door, the interior of the appliance is exposed to warmer air and this causes the sensor to change its resistance and to record a different temperature in the circuitry. The temperature information is used to either turn on or turn off the compressor or other electrical component. Thus, even if sensing opening the door is somehow neutralized, a problem still exists of indirectly causing a change in resistance and recording different temperature-related electronic data that would have been recorded if the door had been left closed.

Although it is possible to solve this problem at the manufacturer level by programming the control circuitry for Sabbath mode, the amount of consumers that would demand such a mode is not great enough to make the manufacturers invest in such a solution. In addition, it would not be convenient or even possible to check if the programming was done in a manner that would satisfy all the demands of strict Sabbath observance.

### SUMMARY OF THE INVENTION

The present invention seeks to provide an external electronic accessory that is connected between the sensors and the control circuitry of a heat-transfer electrical appliance and provides a Sabbath mode of operation, as is described more in detail hereinbelow. The accessory does not rework the pre-programmed operation of the sensors of the appliance, yet eliminates any direct or even indirect human effect on the sensor-microprocessor circuitry. In weekday mode, the sensors sense and send signals to the microprocessor of the appliance in a normal fashion. In Sabbath mode, the sensors are disconnected and the signal that the control circuitry receives is a “fake” signal established by the external electronic accessory. There is no modification of the appliance at all; the manufacturer does nothing and the accessory does nothing to the sensors other than disconnect them in Sabbath mode from the microprocessor.

There is thus provided in accordance with an embodiment of the present invention an external electronic accessory connectable between one or more sensors and control circuitry of a heat-transfer electrical appliance, the external electronic accessory including a processor that selectively disconnects the one or more sensors from the control circuitry and produces a preset fake electrical signal for sending to the control circuitry of the heat-transfer electrical appliance.

In one embodiment, the preset fake electrical signal includes a lower resistance signal and a higher resistance signal.

In one embodiment, a user-friendly interface is provided for pre-programming an operation mode of the accessory.

In one embodiment, the external electronic accessory is in operative communication with an external atmosphere temperature sensor that influences operation of the appliance.

In one embodiment, the processor is operative to record weekday behavior of the appliance in memory and adapt the preset fake electrical signal for a Sabbath mode to follow the weekday behavior.

In one embodiment, the processor is preprogrammed for one or many years ahead with dates of Sabbath and Jewish holidays thereby to adapt the preset fake electrical signal for a Sabbath mode for the dates.

In one embodiment, the preset fake electrical signal includes a preset signal of a certain number of door openings in a period of time, regardless of how many actual door openings occurred.

### BRIEF DESCRIPTION OF THE DRAWINGS

The present invention will be understood and appreciated more fully from the following detailed description taken in conjunction with the drawings in which:

FIG. 1 is a simplified pictorial illustration of an external electronic accessory, constructed and operative in accordance with a non-limiting embodiment of the present invention.

### DETAILED DESCRIPTION OF EMBODIMENTS

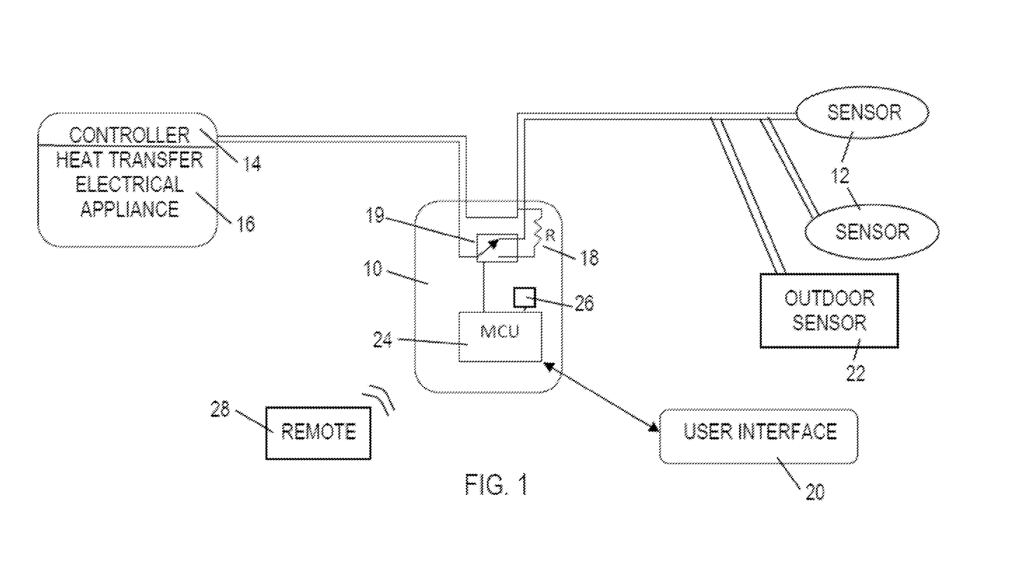

Reference is now made to FIG. 1, which illustrates an external electronic accessory 10, constructed and operative in accordance with a non-limiting embodiment of the present invention.

The external electronic accessory 10 is connected between one or more sensors 12 and control circuitry 14 (also referred to as controller 14) of a heat-transfer electrical appliance 16. In weekday mode, sensors 12 sense and send signals in a normal fashion. As will be explained below, in Sabbath mode, the signal that the control circuitry 14 receives is a “fake” signal established by a processor 24 (which may include resistor circuitry 18) of the external electronic accessory 10. Sensors 12 may include, without limitation, temperature and door-opening sensors, for example.

For example, for the temperature sensor problem, the temperature sensor(s) is (are) disconnected, such as by means of a switch 19 (such as, but not limited to, a relay switch), and instead the external electronic accessory 10 sends the control circuitry 14 one of two resistance signals: a lower resistance (e.g., 2 KΩ), which typically corresponds to a warmer temperature, and a higher resistance (e.g., 50 KΩ), which typically corresponds to a colder temperature. (Whether the resistances correspond to warmer or colder temperatures depends on whether the thermistor has a positive or negative temperature coefficient, and the invention is not limited to either one.) These two resistances may be produced by two resistors or by a single variable resistor 18. The controller 14 operates a compressor or other component (not shown) of appliance 16 in response to these two resistances for time periods that have been preset before the Sabbath (how much time for cooling and how much for heating (or no cooling)). The external electronic accessory 10 may be provided with a user-friendly interface 20 (e.g., touch screen, color-coded commands, etc.) for easily pre-programming the operation mode of the accessory 10.

The external electronic accessory 10 can also communicate with an external atmosphere temperature sensor 22 that influences the operation of the appliance 16.

The external electronic accessory 10 can remain connected to the appliance 16 at all times, wherein the accessory 10 can allow for regular information to pass unimpeded from the sensors 12 to the controller 14 on regular weekdays and automatically go to Sabbath mode before the start of the Sabbath (such as by the switching action of switch 19). The processor 24 of the external electronic accessory 10 may record the weekday behavior of the appliance in memory and can adapt the preset fake electrical signals of the Sabbath mode to follow the weekday behavior—again without any effect, direct or indirect, from any user action. Processor 24 can also modify the Sabbath behavior as a function of the stored weekday behavior, if desired. Processor 24 can be set to have one Sabbath behavior for nighttime and another for daytime. Processor 24 can be preprogrammed for one or many years ahead with the dates of Sabbath and Jewish holidays so that Sabbath mode is automatically entered when these dates arrive.

The processor 24 of the external electronic accessory 10 may also turn off door lights or keep a fan running continuously or other actions to prevent desecration of Sabbath.

For the door-opening sensor problem, processor 24 of the external electronic accessory 10 sends a “fake” door-opening signal to the control circuitry 14 (with the sensor 12 that counts the number of door openings being disconnected). For example, the external electronic accessory 10 can send a preset signal of a certain number of door openings in an hour or other period of time, which has nothing to do with what the user actually did with the door. (Of course, the same holds true if there is a sensor which counts the number of times the door was closed.)

Some door-opening sensors work with infrared beams or light beams. In such a case, the external electronic accessory 10 can include its own infrared or light source 26 (referred to collectively herein as an electromagnetic wave source) that is preset to fake the control circuitry 14 accordingly.

Some refrigerators or freezers have a temperature sensor for defrosting purposes, which also works by means of electrical resistance which changes with temperature. Alternatively, some defrosting modes work with a door-opening sensor. The external electronic accessory 10 can be used in the same manner described above to fake the control circuitry 14 and give artificial temperatures or door-opening counts that eliminate any indirect or direct effect of the user on the defrosting cycle.

The external electronic accessory 10 can also be used to operate an inverter air conditioner, as will be explained below.

An inverter uses a variable-frequency drive to control the speed of the air conditioner compressor motor. This enables very efficient operation of the compressor, and can provide energy savings.

An inverter typically draws a lot of power if it senses the temperature as being far from the final temperature which it is desired to achieve (e.g., the goal temperature may be 25° C. for a room). The inverter will draw little power if the temperature is near the goal temperature. However, if the goal temperature is not reached for a predetermined amount of time, the inverter will “kick in” and draw a lot of power to finally reach the goal temperature. Thus, if the external electronic accessory 10 feeds the inverter two temperatures far from the goal temperature, the inverter will basically work at full or near full capacity most or all of the time, because the inverter is being fed fake temperatures far from the final temperature it is working to achieve. This is unacceptable because it defeats the energy savings of inverters and overworks the inverter. (This is true no matter if the energy source is a generator or mains power.)

Therefore, for inverters, the two resistances provided by the external electronic accessory 10 as described above (warm and cold) are chosen such that one is at the goal temperature and the other is near the goal temperature. In this manner, the inverter reaches the goal and only moves slightly away from the goal, thereby minimizing the amount of energy it expends.

The external electronic accessory 10 of the invention can be wirelessly operated from a remote location by a wireless device 28 (such as a remote control device). Several appliances in one or more locations can be simultaneously controlled by one or more external electronic accessories, which may be located in one central location or in several locations.

Although the invention has been described in conjunction with specific embodiments thereof, many alternatives, modifications and variations are apparent to those skilled in the art. Accordingly, all such alternatives, modifications and variations fall within the spirit and scope of the following claims.

What is claimed is:

1. Apparatus comprising:
an external electronic accessory connectable between one or more sensors and control circuitry of a heat-transfer electrical appliance, said external electronic accessory comprising a processor that selectively disconnects said one or more sensors from said control circuitry and produces a preset fake electrical signal for sending to said control circuitry.

2. The apparatus according to claim 1, wherein said preset fake electrical signal comprises a lower resistance signal and a higher resistance signal.

3. The apparatus according to claim 1, comprising a user-friendly interface for pre-programming an operation mode of said accessory.

4. The apparatus according to claim 1, wherein said external electronic accessory is in operative communication with an external atmosphere temperature sensor that influences operation of said appliance.

5. The apparatus according to claim 1, wherein said processor is operative to record weekday behavior of the appliance in memory and adapt said preset fake electrical signal for a Sabbath mode to follow the weekday behavior.

6. The apparatus according to claim 1, wherein said processor is preprogrammed for one or many years ahead with dates of Sabbath and Jewish holidays thereby to adapt said preset fake electrical signal for a Sabbath mode for said dates.

7. The apparatus according to claim 1, wherein said preset fake electrical signal comprises a preset signal of a certain number of door openings in a period of time, regardless of how many actual door openings occurred.

8. The apparatus according to claim 1, wherein said preset fake electrical signal comprises a signal for operation of a defrosting mode of the appliance.

9. The apparatus according to claim 1, wherein said preset fake electrical signal comprises a signal for operation of an inverter air conditioner.

10. The apparatus according to claim 1, wherein said external electronic accessory is wirelessly operated from a remote location by a wireless device.
